(19) United States
(12) Patent Application Publication
(10) Pub. No.: US 2024/0291930 A1
(43) Pub. Date: Aug. 29, 2024

(54) METHOD FOR COLOR CORRECTING A DIGITAL PRINT

(71) Applicant: AKZENTA PANEELE + PROFILE GMBH, Kaisersesch (DE)

(72) Inventors: Markus KLEMM, Bielefeld (DE); Timo LINNENBRÜGGER, Cochem (DE); Hans-Jürgen HANNIG, Bergisch Gladbach (DE)

(21) Appl. No.: 18/573,257

(22) PCT Filed: Jun. 29, 2022
(86) PCT No.: PCT/EP2022/067920

§ 371 Date: Dec. 21, 2023

(30) Foreign Application Priority Data
Jun. 30, 2021 (EP) 21182815.7

(51) Int. Cl. H04N 1/60; H04N 1/407

(52) U.S. Cl. CPC H04N 1/6033; H04N 1/407

(57) ABSTRACT

The disclosure relates to a method for color correcting a digital print. In a first step, a specified digital image is provided to a digital printer as a color-separate digital image with at least one color channel pattern, wherein each color channel pattern is assigned to a print color channel of the digital printer and has information relating to the printing points, which are to be placed by the printer, of the corresponding print color channel, and a printing point is defined by the printing position and size thereof. The method additionally has the steps of: a) providing correction data for the digital print, said correction data at least comprising a correction value for at least one color channel pattern, b) using the correction data on the color-separate digital image, whereby a color-corrected color-separate digital image is obtained, and c) optionally printing the color-corrected color-separate digital image using the digital printer.

### CROSS-REFERENCE TO RELATED APPLICATIONS

This application is a U.S. National Phase Application under 35 U.S.C. 371 of International Application No. PCT/EP2022/067920, filed on Jun. 29, 2022, which claims the benefit of European Patent Application No. 21182815.7, filed on Jun. 30, 2021. The entire disclosure of the aforementioned European Patent Application is incorporated herein by reference.

### FIELD

The present disclosure relates to a method for color correcting a digital print, a device for performing the method, and a use of the method.

### BACKGROUND

This section provides background information related to the present disclosure which is not necessarily prior art.

Methods for color correcting digital prints are known per se. Therein, deviations from the expected print result are determined and taken into account for the print such that the print corresponds more to the expected print result.

A major problem with outputting digital images is to achieve prints in repeated printing of a digital image, even after longer breaks, that have as small deviations as possible from a reference print. The reasons why deviations occur are of various nature, for example, the print substrate may have differences in color and spreading properties or the printer may change over time.

To quickly correct current color deviations, for example on systems based on an inkjet printer, a color correction may be performed by setting the print head voltage. However, this changes the optimal operating point of the print head and can therefore only be used to a limited extent for correction.

Another possibility is to generate new color-corrected print data with the help of the color management which is part of the output device. Depending on the integration of the color management into the printing machine, the accessibility of the color management for the printing machine operator, as well as the speed of the color management and the total size of the digital image file, this process can take a considerable amount of time.

Other methods that try to avoid resorting to the color management include sending correction signals to the print head control, which implements the correction by adjusting the number and/or size of printing points. A problem with such methods, however, is that special hardware may be necessary for implementation. Furthermore, due to process-related reasons, such methods can not equally take into account the correction in the print feed direction and along the printing width. This can lead to disadvantages in the print result. In particular, with such methods, especially small corrections that are distributed over several printing points due to discrete printing point sizes cannot be distributed evenly in the print feed direction and along the printing width, which can lead to artifacts.

Methods for color correcting digital prints can thus still offer room for improvement. Room for improvement may exist, in particular, in that the color correction can be performed faster and simpler, in particular without having to resort to the preceding color management process and/or having to adjust the print head voltage.

### SUMMARY

This section provides a general summary of the disclosure, and is not a comprehensive disclosure of its full scope or all of its features.

The disclosure proposes a method for color correcting a digital print, wherein, in a first step, a specified digital image is provided to a digital printer as a color-separate digital image with at least one color channel pattern, wherein each color channel pattern is associated with a print color channel of the digital printer and has information relating to the printing points to be placed by the printer of the corresponding print color channel, and a printing point is defined by the printing position and size thereof, wherein the method additionally comprises the steps of:
a) providing correction data for the digital print, wherein the correction data at least comprises a correction value for at least one color channel pattern,
b) using the correction data on the color-separate digital image, wherein a color-corrected color-separate digital image is obtained,
c) optionally printing the color-corrected color-separate digital image using the digital printer.

The disclosure further proposes a method for color correcting a digital print, wherein the digital print includes outputting a specified digital image using a digital printer, wherein the specified digital image is provided to the digital printer as a color-separate digital image with at least one color channel pattern, wherein each color channel pattern is associated with a print color channel of the digital printer and has information relating to the printing points to be placed by the printer of the corresponding print color channel, and wherein a printing point is defined by the printing position and size thereof, wherein the method comprises the steps of:
a) providing correction data for the digital print, wherein the correction data at least comprises a correction value for at least one color channel pattern,
b) using the correction data on the color-separate digital image, wherein a color-corrected color-separate digital image is obtained,
c) optionally printing the color-corrected color-separate digital image using the digital printer.

Within the meaning of the present disclosure, a digital print is, in particular, understood to mean a digital printing method, i.e., a method for printing a digital image using a digital printer.

Within the meaning of the present disclosure, a digital printer is, in particular, understood to mean a device that can output colored printing points on a substrate, which form the corresponding image.

Within the meaning of the present disclosure, a digital image is, in particular, understood to mean a digitally storable image, whose image information is determined through pixels, each having a color value with respect to a color system. A specified digital image within the meaning of the present disclosure is a digital image provided for printing. For example, the specified digital image may be a pixel-based or a vector-based digital image.

That the specified digital image is provided to the digital printer as a color-separate digital image with at least one color channel pattern, wherein each color channel pattern is associated with a print color channel of the digital printer and has information relating to the printing points to be placed by the printer of the corresponding print color channel and wherein a printing point is defined by the printing position and size thereof, is, within the meaning of the disclosure, understood to mean that the specified digital image is provided to the digital printer in particular as a digital image that originates from a RIP (Raster Image Processor) process, which is thus already adapted to the print color channels of the digital printer and, for example, also to the print resolution of the printer. Accordingly, within the meaning of the disclosure, a printing point can be understood to mean a point actually to be printed by the printer.

Within the meaning of the present disclosure, a distinction can therefore be made, in particular, between the specified digital image, which is defined through pixels with color values, and the color-separate digital image, whose color channel patterns are defined through printing points.

Within the meaning of the present disclosure, a color channel pattern is, in particular, understood to mean a part of the digital image that only has the information for one color channel of the color system in which the digital image is stored. For example, the digital image can be defined through color values in the CMYK color system and a color channel pattern only has the color values of the C color channel.

Within the meaning of the present disclosure, a print color channel is, in particular, understood to mean a color channel in which the printer can print. For example, the printer may be provided for printing in the CMYK color system and a print color channel may be the C color channel.

In other words, in particular, it is provided that the digital image is composed of such color channel patterns that correspond to the print color channels of the digital printer. For example, it may be provided that the digital image is determined in the CMYK color system through the color channel patterns of the C and M color channels, and the printer is a printer that can print in the CMYK color system. Thus, the color channel patterns C and M of the digital image are associated with the print color channels C and M, respectively.

In other words, the specified digital image is provided to the digital printer as a color-separate digital image in such a way that it is directly suitable for printing on the digital printer, and has corresponding information relating to the printing points to be placed of the print color channels.

This can advantageously achieve that the specified digital image can be printed directly and it is not necessary to revert to the original specified digital image.

The method comprises the steps of:
a) providing correction data for the digital print, wherein the correction data at least comprises a correction value for at least one color channel pattern,
b) using the correction data on the color-separate digital image, wherein a color-corrected color-separate digital image is obtained,
c) optionally printing the color-corrected color-separate digital image using the digital printer.

Providing correction data for digital printing, within the meaning of the present disclosure, refers, in particular, to providing data that is suitable for describing color deviations of a print of the specified digital image from the specified digital image itself.

Within the meaning of the present disclosure, using the correction data on the color-separate digital image means, in particular, that, when using the correction data, the color-separate digital image is altered in such a way that the color-corrected color-separate digital image takes into account the correction data such that the color deviations from the print of the specified digital image are corrected when printing the color-corrected color-separate digital image. In other words, it is understood that the color-separate digital image, which has already been obtained from the specified digital image through, in particular, a RIP process, is subjected to another RIP process using the correction data. In particular, the correction data is not used on the original specified digital image.

Within the meaning of the present disclosure, a correction value is, in particular, understood to be a value that is proportional to a color deviation of a color of an image printed using the digital printer, particularly also depending on the printing position, from the color of the image used for the print. In other words, a correction value within the meaning of the present disclosure is, in particular, proportional to a color deviation, wherein the color deviation can be specified depending on the printing position. In particular, there may be a certain relationship between the correction value and the color deviation, which depends on the printer used, a measuring device used to determine the color deviation, and/or other equipment used for printing. The relationship between the correction value and the color deviation can preferably be determined by reference measurements.

The prescribed method may advantageously achieve that the color correction can be carried out comparatively faster and simpler. In particular, by using the correction data on the color-separate digital image, it may be achieved that there is no need to resort to the preceding color management process, in particular to the original data of the specified digital image, and also that there is no need to adjust the print head voltage for the color correction. By not having to resort to the original specified digital image, a particularly large amount of time can be saved. For example, depending on the computer speed and image size, the method can generate completely new color-corrected color-separate print files within a few seconds, which can then be printed immediately. The original image files, as well as the color-separate image files ripped originally, remain intact.

Preferably, it may be provided that the information relating to the printing points to be placed by the printer includes printing positions and sizes of the printing points to be placed.

Preferably, it may be provided that the use of the correction data on the color-separate digital image takes into account the color-separate digital image as a whole. In other words, when using the correction data, not only a part, portion, or the like of the color-separate digital image is used but the correction data is used on the color-separate digital image as a whole. In particular, it may preferably be provided that the obtained color-corrected color-separate digital image is obtained as a whole. For example, it may preferably be provided that the color-corrected color-separate digital image has the same storage format as the original color-separate digital image.

The above may, in particular, achieve that the method can be applied without special control hardware. In particular, the color-corrected color-separate digital image may be printed in exactly the same manner as the color-separate digital image originally was. This makes the method particularly flexible to utilize. Furthermore, this may achieve that corrections can be implemented regardless of the printing direction of the specified digital image. Furthermore, it may be achieved that even especially small corrections that need to be distributed over several printing points due to discrete printing point sizes are evenly distributed both in the print feed direction and along the printing width, thereby creating particularly few artifacts.

Preferably, it may be provided that for step c) the color-corrected color-separate digital image as a whole is made available to the digital printer. In particular, it may be provided that the color-corrected color-separate digital image is made available to the digital printer in the same manner as for a print without correction for the color-separate digital image. This may also result in the aforementioned advantages. In particular, this may achieve that the method is able to be utilized flexibly.

Preferably, it may be provided that the correction value is used on the printing points intended for the color channel pattern, particularly by adjusting the printing point sizes of at least a part of the printing points of the color channel pattern depending on the correction value.

This may achieve that the color correction can be performed particularly easily.

For example, it may be provided that the digital image is determined by the color channel patterns of the C and M color channels in the CMYK color system and the printer is a printer that can print in the CMYK color system, wherein the provided correction data describe, for example, that the printed image has a C component that is too strong compared to the specified digital image. The correction value then includes, for example, a negative value for the C color channel, which is used on the sizes of the printing points of the C color channel pattern by shrinking the printing points of the C color channel. Thus, the color-corrected color-separate digital image has a smaller C component compared to the color-separate digital image. When printing the color-corrected color-separate digital image, the print will then have the C component actually intended for the printing of the specified digital image.

By directly using the correction values on the printing point sizes, it may be achieved that the method can be performed particularly easily and quickly.

Preferably, it may be provided that the correction value is not used on the size of printing points, whose size is 0.

Printing points with a size of 0 are understood to be printing points for which it is intended, according to the color-separate digital image, that no printing point is to be placed at this location for at least the affected color channel.

This may achieve that the correction values are not used on locations of the color-separate digital image that have the color value for white. Thus, it may be achieved that the color correction is particularly efficient and does not simultaneously create color artifacts.

Preferably, it may be provided that the sizes of the printing points of the color channel patterns can assume a limited number of discrete printing point size values, in particular a number limited by the digital printer.

A limited number of discrete printing point size values is understood to mean that the printing points can only assume a finite number of different printing point size values. For example, the digital printer may be designed for printing only printing points in 255 or fewer different printing point sizes. In this context, digital printers are usually configured to print, in most cases, fewer than 20, in particular fewer than 10 different printing point sizes.

Preferably, it may be provided that the correction value is used on the sizes of the printing points when using the print correction data in such a way that not every printing point's size value is changed.

This may achieve that even small correction values are taken into account in the color correction, in particular correction values that are smaller than the difference between two successive printing point size values.

Preferably, it may be provided that the correction value is used in such a way that the correction value is distributed over the printing points intended for the color channel pattern, wherein the distribution of the correction value preferably may be performed in such a way that the color difference achieved over all of the printing points in total corresponds to the correction value.

In particular, this is understood to mean that, when using the print correction data, the correction value is used on the sizes of the printing points in such a way that the printing point size changes made in total correspond to the correction value.

For example, correction values that, if used on a printing point, would exceed a maximum possible printing point size may be used on the printing point in such a way that the printing point is assigned the maximum possible printing point size and the remaining correction is achieved by enlarging other printing points in the vicinity of the printing point.

Furthermore, correction values that do not correspond to a discrete printing point difference between two printing point sizes, for example, may be used in such a way that, for example, not every printing point's size is adjusted but, in particular, only every second, third, fourth, or fifth printing point. In this way, it may be achieved that even small correction values can be used.

In other words, the correction value may be represented with the printing point size changes made for the printing points of the color channel pattern.

Preferably, it may be provided that the distribution of the correction value over the printing points intended for the color channel pattern is performed according to the same RIP process on which the specified digital image is based.

This may achieve that the distribution of the correction value over the printing points intended for the color channel pattern automatically takes into account the positions of the printing points of the color channel pattern and/or the limited number of discrete printing point size values.

In other words, the number and position of the printing points originally defined remain and the printing point size is increased or decreased for all or a part of the printing points.

Preferably, it may be provided that, for distributing the correction value over the printing points intended for the color channel pattern, it is determined consecutively, in particular in a specified order, for each printing point of the color channel pattern by which printing point size the printing point should be changed.

Preferably, it may be provided that, when using the correction value on the respective printing point position, this position can only assume the same limited number of printing point size values as the printing points.

Preferably, it may be provided that the specified order corresponds to the same RIP process that the specified digital image is based on.

Preferably, it may be provided that, when using the correction value determined for the respective printing position consecutively, in the case that the correction value for a determined printing point position reaches a threshold value, the size value of the printing point of the color channel pattern with the corresponding printing point position is increased or decreased accordingly when using the correction data.

In other words, it may be provided that, while distributing the correction value, due to using the correction data on the color-separate image, the size of a printing point is only adjusted if the corresponding correction value for the printing point position of the corresponding printing point reaches a determined threshold value.

This may achieve that a limited number of printing point sizes limited by the printing technique is appropriately taken into account in the color correction such that an efficient color correction is still possible.

Preferably, it may be provided that the threshold value corresponds to the color value difference between two successive printing point size values, wherein, in the case that the correction value reaches n times the threshold value, the printing point size value of the printing points of the color channel pattern is increased or decreased accordingly by n printing point size values when using the correction data, wherein n is a natural number.

Within the meaning of the present disclosure, successive printing point size values are understood to mean the size values of one possible printing point size and the next larger or smaller printing point size.

This may achieve that the color correction is performed well proportionally for both small and large printing points and is also especially efficient for both small and large correction values.

Preferably, it may be provided that, when using the correction value determined for the respective printing position consecutively, in the case that the correction value for a determined printing point position does not reach the threshold value, the size value of the printing point of the color channel pattern with the corresponding printing point position is not increased or decreased accordingly when using the correction data, wherein the correction value is taken into account for determining the next printing point.

In other words, it may be provided that for correction values smaller than the smallest printing point size difference, the correction value, when determining consecutively by which printing point size a printing point should be changed, is accumulated or distributed over other printing points until the threshold value is reached and the printing point size value of the corresponding printing point is increased or decreased.

Preferably, it may be provided that the correction value is distributed over various uncorrected printing points using an algorithm, for example an error distribution algorithm.

Preferably, it may be provided that, when determining consecutively by which printing point size a printing point should be changed, in the case that the correction value exceeds n times the threshold value, the difference between n times the threshold value and the correction value is taken into account for determining the next printing point.

In other words, it may be provided that for correction values that do not exactly correspond to a possible printing point size difference, the remaining correction value, when determining consecutively by which printing point size a printing point should be changed, is accumulated or distributed until the accumulated remaining correction values reach the threshold value and the printing point size value of the corresponding printing point is increased or decreased by n+1 printing point size values.

Preferably, it may be provided that, in the case that the printing point size value of a printing point should become smaller than the smallest possible printing point size value when using the correction data, the size of the printing point is set to 0.

Within the meaning of the present disclosure, this is understood to mean that it is provided that no printing point is placed at the corresponding location in the color-corrected color-separate digital image at least for the affected color channel.

Preferably, it may be provided that, in the case that the printing point size value of a printing point should become larger than the largest possible printing point size value when using the correction data, the size of the printing point is set to the largest possible printing point size value.

Preferably, it may be provided that using the correction values for the respective printing position only occurs if there is a printing point at this location in the original rasterized image that has a printing point size larger than zero.

Preferably, it may be provided that, when changing the printing point size value of the printing points of the color channel pattern while using the correction data, an error distribution algorithm (dithering) is used, for example a Floyd-Steinberg algorithm.

Within the meaning of the present disclosure, using an error distribution algorithm is understood to mean that the correction values are distributed to adjacent or nearby printing points according to an algorithm such as one useable in the RIP process when creating color-separate digital images. In particular, it may be provided that the distribution is not only performed over printing points in the intended print feed direction but also independently in any direction, for example also transversely to the intended print feed direction.

This may achieve that the color correction has a more even effect and artifacts can be avoided.

In particular, it may preferably be provided that the use of the error distribution algorithm occurs in cases where the size value of a printing point should become smaller than the smallest possible printing point size value when using the correction data and the size of the printing point is set to 0, and/or in cases where the size value of a printing point should become larger than the largest possible printing point size value when using the correction data and the size of the printing point is set to the largest possible printing point size value.

This may achieve that the color correction is particularly successful in areas with high or low color density.

In a preferred configuration, it may be provided that the use of the correction data on the color-separate digital image occurs at every location of the digital image regardless of a color density of the color-separate digital image.

This may achieve that the color correction is particularly simple and a good result can still be achieved.

In an alternative preferred configuration, it may be provided that the use of the correction data on the color-separate digital image depends on a density map generated from at least one color channel pattern, wherein the density map includes information relating to a color density of the color channel pattern depending on the printing position. Within the meaning of the present disclosure, the term color density may, in particular, be understood to mean color saturation. In other words, it may be provided that a color channel pattern is processed in such a way that a color saturation is obtained depending on the printing position.

This may achieve that the color correction can be further improved. In particular, the color correction may therefore be particularly precise even in areas with very different color densities.

Preferably, it may be provided that the density map was created from the color channel pattern of the color-separate digital image, wherein the color density depending on the printing position of the color channel pattern is preferably obtained using a blurring tool.

This may achieve that the density map can be obtained in a particularly uncomplicated and quick manner, especially without resorting to the preceding color management process and the original specified digital image.

Preferably, it may be provided that the correction data is used on the color channel pattern of the color-separate digital image depending on a gradation curve.

Within the meaning of the present disclosure, a gradation curve is to be understood to be a curve that describes the relationship between at least two color densities, and in the present case is understood to describe a factor depending on the color density that can be used on the correction value.

Thus, a gradation curve representing the strength of the correction depending on the color density may be used for the color correction. For example, the gradation curve may provide that the areas with a lower color density are corrected proportionally less than the areas of high color density, or vice versa.

This may achieve that the details of the color correction can be set particularly quickly and easily.

Preferably, it may be provided that the correction value depends on the printing width of the digital printer.

This may advantageously achieve that errors can be corrected which occur, in particular, due to variations at the print head of the digital printer along the printing width, i.e. transverse to a print feed direction.

Preferably, it may be provided that providing the correction data for the digital print in step a) includes printing the color-separate digital image and/or a digital test image using the digital printer and acquiring color values of the printed color-separate digital image and/or digital test image using an optical color measuring apparatus, wherein the correction values are created based on deviations of the color value measured for a printing position from the color value expected for the specified digital image and/or the digital test image at this printing position.

A digital test image is understood to be a specified digital image that is configured in such a way that correction data can be obtained particularly efficiently from the print of the test image.

The aforementioned acquiring of color values may achieve that the correction data is particularly reliable.

In particular, it may be provided that the printing is performed on the same substrate on which the specified digital image is to be printed.

This may advantageously achieve that effects of the substrate can also be easily taken into account in the color correction.

Preferably, it may be provided that steps a) and b) are performed iteratively several times in succession. In particular, it may be provided that the providing of correction data in a step a) following step b) includes printing the color-corrected color-separate digital image, wherein, in the subsequent step b), the correction data is used on the already color-corrected color-separate digital image and a further color-corrected color-separate digital image is obtained.

This may achieve that the color correction achieves a particularly homogeneous print result.

In particular, it may be provided that steps a) and b) are performed iteratively until the result of the correction is good enough. In particular, steps a) and b) may be performed until the correction values provided in step a) are sufficiently small.

Optionally, the success of the method may be checked, wherein the specified digital image is printed with the correction data used correspondingly

Preferably, it may be provided that the optical color measuring apparatus is selected from the group consisting of a color sensor, a colorimeter, a spectrophotometer, a digital camera, and a spectral densitometer, wherein the optical color measuring apparatus is preferably based on the same color model as the digital printer.

Preferably, it may be provided that the acquiring of the color values is optionally performed multiple consecutive times with different settings of the optical color measuring apparatus, especially under different lighting conditions and/or with different exposure times.

This may achieve that even very small color deviations can be detected.

Preferably, it may be provided that the specified digital image has a color model selected from RGB, CMY, and CMYK, especially wherein the color model is CMYK.

Preferably, it may be provided that the method includes creating the information relating to the printing points to be placed by the printer, wherein step b) is performed while creating the information relating to the printing points to be placed by the printer, especially each time after a printing point has been created.

This means that, during the RIP process of the specified digital image, the correction data is used according to the disclosure, whereby the correction data is not taken into account before the creation of a printing point but is only used on a printing point, as previously described, after it has been created.

Thus, while creating the digital image to be printed, the same correction results as with a correction according to the RIP process may be advantageously achieved.

Preferably, it may be provided that printing the color-corrected color-separate digital image using the digital printer includes printing of decors, especially printing of decors for decorative panels.

The disclosure also proposes a device comprising a data storage, a computing unit, a digital printer for outputting a specified digital image, and optionally an optical color measuring apparatus, wherein the device is configured to perform the aforementioned method.

The disclosure also proposes a use of the aforementioned method or the aforementioned device for color correcting the printing of decors, particularly for the printing of decors for decorative panels.

Surprisingly, it has been shown that the aforementioned method is particularly suitable for color correcting in such applications, since especially in the printing of decorative panels it must be ensured as much as possible that the color does not deviate between different batches, since these may be installed next to each other, thus making color deviations particularly noticeable. In addition, such applications require a high throughput, which makes a particularly fast color correction, as can be achieved with the present disclosure, particularly advantageous.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for color correcting a digital print, wherein, in a first step, a specified digital image is provided to a digital printer as a color-separate digital image with at least one color channel pattern, wherein each color channel pattern is associated with a print color channel of the digital printer and has information relating to the printing points to be placed by the printer of the corresponding print color channel, and a printing point is defined by the printing position and size thereof, wherein the method additionally comprises the steps of:
a) providing correction data for the digital print, wherein the correction data at least comprises a correction value for at least one color channel pattern,
b) using the correction data on the color-separate digital image, wherein a color-corrected color-separate digital image is obtained,
c) optionally printing the color-corrected color-separate digital image using the digital printer.

2. The method according to claim 1, wherein the correction value is used on the printing points intended for the color channel pattern, particularly by adjusting the printing point sizes of at least a part of the printing points of the color channel pattern depending on the correction value.

3. The method according to claim 2, wherein the correction value is not used on the size of printing points, whose size is 0.

4. The method according to claim 2, wherein the sizes of the printing points of the color channel patterns can assume a limited number of discrete printing point size values, in particular a number limited by the digital printer.

5. The method according to claim 1, wherein the correction value is used in such a way that the correction value is distributed over the printing points intended for the color channel pattern, wherein the distribution of the correction value is performed such that the color difference achieved over all of the printing points in total corresponds to the correction value.

6. The method according to claim 4, wherein, in the case that the printing point size value of a printing point should become smaller than the smallest possible printing point size value when using the correction data, the size of the printing point is set to 0.

7. The method according to claim 4, wherein, in the case that the printing point size value of a printing point should become larger than the largest possible printing point size value when using the correction data, the size of the printing point is set to the largest possible printing point size value.

8. The method according to claim 4, wherein, when changing the printing point size value of the printing points of the color channel pattern while using the correction data, an error distribution algorithm (dithering) is used, for example a Floyd-Steinberg algorithm.

9. The method according to claim 1, wherein the use of the correction data on the color-separate digital image is performed depending on a density map generated from at least one color channel pattern, wherein the density map includes information relating to the color density of the color channel pattern depending on the printing position.

10. The method according to claim 9, wherein the density map was created from the color channel pattern of the color-separate digital image, wherein the color density depending on the printing position of the color channel pattern is preferably obtained using a blurring tool.

11. The method according to claim 9, wherein the correction data is used on the color channel pattern of the color-separate digital image depending on a gradation curve.

12. The method according to claim 1, wherein the correction value depends on the printing width of the digital printer.

13. The method according to claim 1, wherein providing the correction data for the digital print in step a) includes printing the color-separate digital image and/or a digital test image using the digital printer and acquiring color values of the printed color-separate digital image and/or digital test image using an optical color measuring apparatus, wherein the correction values are created based on deviations of the color value measured for a printing position from the color value expected for the specified digital image and/or the digital test image at this printing position.

14. A device comprising a data storage, a computing unit, a digital printer for outputting a specified digital image, and optionally an optical color measuring apparatus, wherein the device is configured to perform the method according to claim 1.

15. The method according to claim 1, wherein color correcting is for the printing of decors, in particular the printing of decors with low color diversity, for example, wooden and/or stone decors.
